(19) United States
(12) Patent Application Publication
(10) Pub. No.: US 2018/0186129 A1
(43) Pub. Date: Jul. 5, 2018

(54) BIODEGRADABLE SHEETS

(71) Applicant: Tipa Corp. Ltd, Hod Hasharon (IL)

(72) Inventors: Tal NEUMAN, Ramot Ha'shavim (IL); Nili KONIECZNY, Tel Aviv (IL); Shai GARTY, Rehovot (IL)

(73) Assignee: Tipa Corp. Ltd, Hod Hasharon (IL)

(21) Appl. No.: 15/739,700

(22) PCT Filed: Jun. 22, 2016
(86) PCT No.: PCT/IL2016/050663

§ 371 Date: Dec. 22, 2017

(30) Foreign Application Priority Data
Jun. 23, 2015 (GB) 1510993.7

(51) Int. Cl. B32B 27/08; B32B 27/36

(52) U.S. Cl. CPC B32B 27/08; B32B 27/36; B32B 2307/7163; B32B 2250/244; B32B 2367/00; B32B 2307/558; B32B 2270/00

(57) ABSTRACT

The present invention is directed to biodegradable sheets, and in particular to biodegradable sheets including a polymer layer comprising from about 70 to about 90% (w/w) PBSA and from about 10 to about 30% (w/w) PLA, either in an inner layer, or in an outer layer wherein, if in the outer layer the sheet includes an inner layer comprising PBAT.

### FIELD OF THE INVENTION

The present invention, is directed to biodegradable sheets, and in particular to biodegradable sheets including a polymer layer comprising from about 70 to about 90% (w/w) polybutylene succinate adipate (PBSA) and from about 10 to about 30% (w/w) poly(lactic acid) (PLA).

### BACKGROUND OF THE INVENTION

The use of biodegradable materials had increased over the past years due to the environmentally beneficial properties of such materials. Such materials are now commonly used in the manufacture of a wide range of products, including various types of plastic bags and other forms of packaging. In response to the demand for more environmentally friendly packaging materials, a number of new biopolymers have been developed that have been shown to biodegrade when discarded into the environment.

Examples of such polymers include polyesteramide (PEA), modified polyethylene terephthalate (PET). biopolymers based on polylactic acid (PLA), polyhydroxyalkanoates (PHA), which include polyhydroxybutyrate (PHB), polyhydroxyvalerate (PHV) and polyhydroxybutyrate-hydroxyvalerate copolymer (PHBV), and poly (epsilon-caprolactone) (PCL).

Each of the foregoing biopolymers has unique properties, benefits and weaknesses. For example, PHB and PLA tend to be strong but are also quite rigid or even brittle. This makes them poor candidates when flexible sheets are desired, such as for use in making wraps, bags and other packaging materials requiring good bend and folding capability.

On the other hand, biopolymers, such as PHBV and polybutylene adipate terphtalate (PBAT), are many times more flexible than the biopolymers discussed above, but have relatively low melting points so that they tend to be self-adhering and unstable when newly processed and/or exposed to heat.

Further, due to the limited number of biodegradable polymers, it is often difficult, or even impossible, to identify a single polymer or copolymer that meets all, or even most, of the desired performance criteria for a given application. For these and other reasons, biodegradable polymers are not as widely used in the area of food packaging materials, particularly in the field of liquid receptacles, as desired for ecological reasons.

In addition, the biodegradable sheets known today are mostly opaque, having low light transmittance and high haze. Further, the known biodegradable sheets either do not include barrier layers or include amounts and types of barrier layers that cause the sheets to be generally highly permeable to gases, having both a high oxygen transmission rate and a high water vapor transmission rate, and thus they cannot serve as long term food or drink receptacles. Additionally, the physical strength of known biodegradable sheets, measured by parameters, such as stress at maximum load, strain at break, and Young's Modulus, is lacking and, therefore, is deficient when used as packaging, particularly when it is desirable to package liquids.

International Patent Publication No. WO 2011/158240 to the assignee of the present application discloses biodegradable sheets and an array of separable pouches for liquids.

International Patent Publication No. WO 2013/088443 to the assignee of the present application discloses a biodegradable sheet comprising a gas barrier material, which is a nanoclay and/or polyvinyl alcohol.

International Patent Publication No. WO 2013/186778 to the assignee of the present application discloses a biodegradable sheet comprising at least one layer, which comprises a biodegradable polymer and surface treated nanoclay particles and/or polyvinyl alcohol (PVOH) grafted with a crosslinker and polybutylene succinate (PBS) or polybutylene succinate adipate (PBSA).

There remains a need for a strong yet flexible and biodegradable packaging with high impact resistance.

### SUMMARY OF THE INVENTION

The present invention, in at least some embodiments, is directed to biodegradable sheets including a polymer layer comprising from about 70 to about 90% (w/w) PBSA and from about 10 to about 30% (w/w) PLA.

The biodegradable sheets disclosed herein, in at least some embodiments thereof, have high impact resistance and excellent flexibility and physical strength.

According to an aspect of some embodiments of the present invention, there is provided a biodegradable sheet comprises a first outer polymer layer, a second outer polymer layer and at least a polymer layer between the first and the second outer polymer layers, wherein the first inner polymer layer comprises from about 70 to about 90% (w/w) PBSA and from about 10 to about 30% (w/w) PLA.

In some such embodiments, the first inner polymer layer consists of from about 70 to about 90% (w/w) PBSA and from about 10 to about 30% (w/w) PLA.

In some embodiments, the first inner layer comprises from about 75 to about 85% (w/w) PBSA and from about 15 to about 25% (w/w) PLA, such as about 85% (w/w) PBSA and about 15% (W/W) PLA, or about 75% (w/w) PBSA and about 25% (W/W) PLA.

In some embodiments, the first inner layer consists of from about 75 to about 85% (w/w) PBSA and from about 15 to about 25% (w/w) PLA, such as about 85% (w/w) PBSA and about 15% (W/W) PLA, or about 75% (w/w) PBSA and about 25% (W/W) PLA.

In some embodiments, the first outer polymer layer comprises PBSA. In some embodiments, the second outer polymer layer comprises PBSA. In some embodiments, both the first and second outer polymer layers comprise PBSA.

In some embodiments, the first outer polymer layer consists of PBSA. In some embodiments, the second outer polymer layer consists of PBSA. In some embodiments, both the first and second outer polymer layers consist of PBSA

In some embodiments, the first outer polymer layer comprises PBS. In some embodiments, the second outer polymer layer comprises PBS.

In some embodiments, the first outer polymer layer consists of PBS. In some embodiments, the second outer polymer layer consists of PBS

In some embodiments, the first outer layer comprises PBSA and the second outer layer comprises PBS. In some embodiments, the first outer layer comprises PBSA and the second outer layer comprises PBS.

In some embodiments, the first outer layer consists of PBSA and the second outer layer consists of PBS. In some embodiments, the first outer layer consists of PBSA and the second outer layer consists of PBS.

According to an aspect of some embodiments of the present invention, there is a biodegradable sheet comprising a first outer polymer layer, a second outer polymer layer and at least a first inner polymer layer between the first and second outer polymer layers, wherein the first outer polymer layer comprises from about 70 to about 90% (w/w) PBSA and from about 10 to about 30% (w/w) PLA.

According to an aspect of some embodiments of the present invention, there is a biodegradable sheet comprising a first outer polymer layer, a second outer polymer layer and at least a first inner polymer layer between the first and second outer polymer layers, wherein the first outer polymer layer consists of from about 70 to about 90% (w/w) PBSA and from about 10 to about 30% (w/w) PLA.

In some such embodiments, the biodegradable sheet comprises from about 75 to about 85% (w/w) PBSA and from about 15 to about 25% (w/w) PLA, such as about 85% (w/w) PBSA and about 15% (w/w) PLA or about 75% (w/w) PBSA and about 25% (w/w) PLA. In some embodiments, wherein at least one of the first outer polymer layer and the second outer polymer layer comprises from about 70 to about 90% (w/w) PBSA and from about 10 to about 30% (w/w) PLA, the first inner polymer layer comprises PBAT. In some such embodiments, the first inner polymer layer consists of PBAT.

In some such embodiments, the biodegradable sheet consists of from about 75 to about 85% (w/w) PBSA and from about 15 to about 25% (w/w) PLA, such as about 85% (w/w) PBSA and about 15% (w/w) PLA or about 75% (w/w) PBSA and about 25% (w/w) PLA. In some embodiments, wherein at least one of the first outer polymer layer and the second outer polymer layer consists of from about 70 to about 90% (w/w) PBSA and from about 10 to about 30% (w/w) PLA, the first inner polymer layer comprises PBAT. In some such embodiments, the first inner polymer layer consists of 100% PBAT.

Alternatively, in some embodiments, the first inner polymer layer comprises from about 85% to about 95% (w/w) PBAT and from about 5% to about 15% (w/w) PLA. In some embodiments, the first inner polymer layer comprises about 90% (w/w) PBAT and about 10% (w/w) PLA.

In some embodiments, the first inner polymer layer consists of from about 85% to about 95% (w/w) PBAT and from about 5% to about 15% (w/w) PLA. In some embodiments, the first inner polymer layer consists of about 90% (w/w) PBAT and about 10% (w/w) PLA.

In some embodiments wherein the first outer polymer layer comprises from about 70 to about 90% (w/w) PBSA and from about 10 to about 30% (w/w) PLA and the first inner polymer layer comprises PBAT, the second outer polymer layer comprises PBSA.

In some embodiments wherein the first outer polymer layer comprises or consists of from about 70 to about 90% (w/w) PBSA and from about 10 to about 30% (w/w) PLA and the first inner polymer layer comprises or consists of PBAT, the second outer polymer layer comprises or consists of PBSA.

In some embodiments, the first inner polymer layer, first outer polymer layer and second outer polymer layer are prepared by cast film extrusion.

In some embodiments, the first inner polymer layer, first outer polymer layer and second outer polymer layer are prepared by blown film extrusion.

In some embodiments, the first inner polymer layer, first outer polymer layer and second outer polymer layer are co-extruded.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 is a graph showing dart drop impact as a function of PBSA content.

### DETAILED DESCRIPTION OF THE INVENTION

### Definitions

Unless otherwise defined, all technical and scientific terms used herein have the same meaning as commonly understood by one of ordinary skill in the art to which the invention pertains. In case of conflict, the specification, including definitions, takes precedence.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

It is to be noted that, as used herein, the singular forms “a”, “an” and “the” include plural forms unless the content clearly dictates otherwise. Where aspects or embodiments are described in terms of Markush groups or other grouping of alternatives, those skilled in the art will recognize that the invention is also thereby described in terms of any individual member or subgroup of members of the group.

As used herein, when a numerical value is preceded by the term “about”, the term “about” is intended to indicate +/−10%.

As used herein, the terms “comprising”, “including”, “having” and grammatical variants thereof are to be taken as specifying the stated features, integers, steps or components but do not preclude the addition of one or more additional features, integers, steps, components or groups thereof. These terms encompass the terms “consisting of” and “consisting essentially of”.

The biodegradable compositions according to the invention can be used to manufacture a wide variety of articles of manufacture, including articles useful for packaging solid, semi-solid or liquid substances, including ingestible substances such as food substances, drinks and medicines.

The term “biodegradable” as used herein is to be understood to include a polymer, polymer mixture, or polymer-containing sheet that degrades through the action of living organisms, air, water or any combinations thereof within 180 days in a controlled-condition industrial compost facility with high ventilation and controlled humidity. Biodegradable polyester degradation is initially by hydrolysis, to eventually break the polymer into short oligomers, and later by microbial degradation, or microbial digestion.

The term “sheet” as used herein is to be understood as having its customary meanings as used in the thermoplastic and packaging arts and includes the term “film”. Generally, “film” refers to a sheet having a thickness of about 250 μm or less, 200 μm or less, 150 μm or less, 100 μm or less, 80 μm or less or 70 μm or less. Such sheets may have any suitable thickness, may be of a single polymer layer or of multiple polymer layers having between two to ten layers. Such sheets may be manufactured using any suitable method including blown film extrusion and cast film extrusion.

In some embodiments, the total thickness of the sheet is less than about 60 μm, in some embodiments less than about 50 μm, less than about 40 μm or even less than about 30 μm.

The biodegradable compositions according to the invention can be used to manufacture a wide variety of articles of manufacture, including articles useful to package solid and liquid substances, including food substances. Thus, the sheets according to this invention include sheets having a wide variety of thicknesses (both measured and calculated) and layers, for example 1, 2, 3, 4, 5, or more layers. A sheet may be generated by methods known in the art, for example, cast film extrusion, blown film extrusion, co-extrusion.

As known in the art, multilayer sheets are produced by co-extrusion, lamination or combination thereof. In lamination, at least two previously-made sheets are mutually adhered, for example by heat, pressure and/or adhesive.

As known in to a person having ordinary skill in the art, some of the polymers discussed herein have one or more names or spelling thereof. For example, poly(epsilon-caprolactone), poly(caprolactone) and polycaprolactone are synonymous and the three terms are used interchangeably. Similarly, polylactic acid and poly(lactic acid) are synonymous.

The present invention, in at least some embodiments, is directed to biodegradable sheets and films including a layer comprising (in some embodiments, consisting of) from about 70 to about 90% (w/w) PBSA and from about 10 to about 30% (w/w) PLA, and in particular, to such sheets wherein the polymer layer comprising or consisting of from about 70 to about 90% (w/w) PBSA and from about 10 to about 30% (w/w) PLA is either present as an inner layer, or is present as an outer layer wherein the sheet further includes an inner layer comprising (in some embodiments, consisting of) polybutylene adipate terphtalate (PBAT).

The biodegradable sheet may comprise a single layer comprising ((in some embodiments, consisting of) from about 70 to about 90% (w/w) PBSA and from about 10 to about 30% (w/w) PLA.

The biodegradable sheet may comprise multiple layers, wherein at least one layer comprises (in some embodiments, consists of) from about 70 to about 90% (w/w) PBSA and from about 10 to about 30% (w/w) PLA. The at least one layer comprising or consisting of from about 70 to about 90% (w/w) PBSA and from about 10 to about 30% (w/w) PLA may be an inner layer or an outer layer of the biodegradable sheet.

According to an aspect of some embodiments of the present invention, there is provided a biodegradable sheet comprising a first outer polymer layer, a second outer polymer layer and at least a first inner polymer layer between the first and second outer polymer layers, wherein the first inner polymer layer comprises (in some embodiments, consists of) from about 70 to about 90% (w/w) PBSA and from about 10 to about 30% (w/w) PLA, such as, for example about 70% (w/w) PBSA and about 30% (w/w) PLA, about 75% (w/w) PBSA and about 25% (w/w) PLA, about 80% (w/w) PBSA and about 20% (w/w) PLA, about 85% (w/w) PBSA and about 15% (w/w) PLA and about 90% (w/w) PBSA and about 10% (w/w) PLA.

In some embodiments, the first inner polymer layer has a thickness of from about 15 to about 40 μm. In some embodiments, the inner polymer layer has a thickness of from about 15 to about 35 μm, such as, for example, about 15 μm, about 16 μm, about 17 μm, about 18 μm, about 19 μm, about 20 μm, about 21 μm, about 22 μm, about 23 μm, about 24 μm, 25 μm, about 26 μm, about 27 μm, about 28 μm, about 29 μm, about 30 μm, about 31 μm, about 32 μm, about 33 μm, about 34 μm, or about 35 μm. In some embodiments, the thickness is between about 30 μm and about 32 μm.

In some embodiments, the first outer polymer layer comprises PBSA. In some embodiments, the second outer polymer layer comprises PBSA. In some embodiments, both the first and second outer polymer layers comprise PBSA. In some embodiments, the first outer polymer layer consists of PBSA. In some embodiments, the second outer polymer layer consists of PBSA. In some embodiments, both the first and second outer polymer layers consist of PBSA. In some such embodiments, wherein at least one of the first and second polymer layers comprises or consists of PBSA, the at least one polymer layer comprising or consisting of PBSA has a thickness of from about 3 to about 10 μm, such as, for example, about 3 μm, about 4 μm, about 5 μm, about 6 μm, about 7 μm, about 8 μm, about 9 μm or about 10 μm. In some preferred embodiments, the thickness is about 4 μm.

In some embodiments, the first outer polymer layer comprises PBS. In some embodiments, the second outer polymer layer comprises PBS. In some embodiments, the first outer polymer layer consists of PBS. In some embodiments, the second outer polymer layer consists of PBS. In some such embodiments, wherein the first or second outer polymer layer comprises or consists of PBS, the layer comprising or consisting of PBS has a thickness of from about 5 to about 10 μm, such as, for example, about 5 μm, about 6 μm, about 7 μm, about 8 μm, about 9 μm, or about 10 μm.

In some embodiments, at least one of the first outer polymer layer and the second outer polymer layer, such as the first outer polymer layer, the second outer polymer layer, or both the first and the second outer polymer layers, comprises (in some embodiments, consists of), from about 70 to about 90% (w/w) PBSA and from about 5 to about 35% (w/w) PLA, more preferably from about 75 to about 85% (w/w) PBSA and from about 15 to about 25% (w/w) PLA, such as, for example, about 85% (w/w) PBSA and about 15% (w/w) PLA, or about 75% (w/w) PBSA and about 25% (w/w) PLA. In some such embodiments, wherein at least one of the first outer polymer layer and the second outer polymer layer comprises or consists of from about 70 to about 90% (w/w) PBSA and from about 10 to about 30% (w/w) PLA, the layer comprising or consisting of from about 70 to about 90% (w/w) PBSA and from about 10 to about 30% (w/w) PLA has a thickness of from about 10 to about 20 μm, such as from about 16 to about 18 μm.

In some embodiments, the first inner polymer layer and the first outer polymer layer comprises (in some embodiments, consists of) about 75% (w/w) PBSA and about 25% (w/w) PLA or about 85% (w/w) PBSA and about 15% (w/w) PLA. In some such embodiments, the polymer layer preferably has a thickness of from about 15 μm to about 20 μm, such as about 15 μm, about 16 μm, about 17 μm, about 18 μm, about 19 μm or about 20 μm.

In some such embodiments, the at least one outer polymer layer comprising or consisting of from about 70 to about 90% (w/w) PBSA and from about 10 to about 30% (w/w) PLA has a thickness of from about 5 to about 20 μm, such as about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm or about 20 μm.

In some embodiments, wherein at least one of the first outer polymer layer and the second outer polymer layer comprises or consists of from about 70 to about 90% (w/w) PBSA and from about 10 to about 30% (w/w) PLA, the first inner polymer layer comprises a composition other than from about 70 to about 90% (w/w) PBSA and from about 10 to about 30% (w/w) PLA.

In some embodiments, wherein at least one of the first outer polymer layer and the second outer polymer layer comprises or consists of from about 70 to about 90% (w/w) PBSA and from about 10 to about 30% (w/w) PLA, the first inner polymer layer comprises or consists of from about 70 to about 90% (w/w) PBSA and from about 10 to about 30% (w/w) PLA. In some such embodiments, the first outer polymer layer or the second outer polymer layer and the first inner layer comprise or consist of from about 70 to about 90% (w/w) PBSA and from about 10 to about 30% (w/w) PLA. In some embodiments, each of the first outer polymer layer, the second outer polymer layer and the first inner polymer layer comprises or consists of from about 70 to about 90% (w/w) PBSA and from about 10 to about 30% (w/w) PLA.

According to an aspect of some embodiments of the present invention, there is provided a biodegradable sheet comprising a first outer polymer layer, a second outer polymer layer and at least a first inner polymer layer between the first and second outer polymer layers, wherein at least one of the first outer polymer layer and the second outer polymer layer, such as the first outer polymer layer, the second outer polymer layer, or both the first and second outer polymer layers, comprises (in some embodiments, consists of) from about 70 to about 90% (w/w) PBSA and from about 10 to about 30% (w/w) PLA, such as, for example about 70% (w/w) PBSA and about 30% (w/w) PLA, about 75% (w/w) PBSA and about 25% (w/w) PLA, about 80% (w/w) PBSA and about 20% (w/w) PLA, about 85% (w/w) PBSA and about 15% (w/w) PLA and about 90% (w/w) PBSA and about 10% (w/w) PLA. In some embodiments, the first outer polymer layer or the second outer polymer layer comprising or consisting of from about 70 to about 90% (w/w) PBSA and from about 10 to about 30% (w/w) PLA has a thickness of from about 5 to about 20 μm, such as about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm or about 20 μm.

In some such embodiments, wherein the first outer layer comprises or consists of from about 70 to about 90% (w/w) PBSA and from about 10 to about 30% (w/w) PLA, the first inner layer comprises PBAT.

In some such embodiments, wherein the first outer layer comprises or consists of from about 70 to about 90% (w/w) PBSA and from about 10 to about 30% (w/w) PLA, the first inner layer comprises PBAT, either alone or in a composition comprising PLA, such as from about 85% to about 95% (w/w) PBAT and from about 5% to about 15% (w/w) PLA, such as, for example, about 90% (w/w) PBAT and about 10% (w/w) PLA. In some such embodiments, the first inner layer consists of PBAT.

In some embodiments, the first inner polymer layer comprising or consisting of PBAT has a thickness of from about 15 to about 40 μm, such as, for example, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, about 30 μm, about 31 μm, about 32 μm, about 33 μm, about 34 μm, about 35 μm, about 36 μm, about 37 μm, about 38 μm, about 39 μm, or about 40 μm.

In some embodiments, the second outer polymer layer comprises PBSA. In some embodiments, the second outer polymer layer consists of PBSA.

In some embodiments, the second outer polymer layer comprises PBS. In some embodiments, the second outer polymer layer consists of PBS.

In some embodiments, wherein the second outer polymer layer comprises or consists of PBSA or PBS, the second outer polymer layer has a thickness of from about 4 to about 8 μm, such as, for example about 4 μm, about 5 μm, about 6 μm, about 7 μm or about 8 μm. In some preferred embodiments, the thickness is about 4 μm.

In some embodiments, at least one of the first inner polymer layer, first outer polymer layer and second outer polymer layer are prepared by cast film extrusion.

In some embodiments, at least one of the first inner polymer layer, first outer polymer layer and second outer polymer layer are prepared by blown film extrusion.

In some embodiments, at least two of the first inner polymer layer, first outer polymer layer and second outer polymer layer co-extruded. In some embodiments, the first outer polymer layer and the first inner polymer layer are co-extruded. In some embodiments, the second outer layer and the first inner polymer layer are co-extruded. In some embodiments, the first inner polymer layer, first outer polymer layer and second outer polymer layer co-extruded.

In some embodiments, the biodegradable sheet disclosed herein comprises a laminated structure i.e., the sheet is made by producing at least two layers by extrusion, and subsequently the layers are laminated to form the sheet.

In some embodiments, one or more of the first inner polymer layer, first outer polymer layer and second outer polymer layer are metallized on one or both sides. In some embodiments, the first inner polymer layer is metallized on one side. In some embodiments, the first inner polymer layer is metallized on both sides. In some embodiments, the first outer polymer layer is metallized on one side. In some embodiments, the first outer polymer layer is metallized on both sides. In some embodiments, the second outer polymer layer is metallized on one side. In some embodiments, the second outer polymer layer is metallized on both sides.

In some embodiments, one or more of the first inner polymer layer, first outer polymer layer and second outer polymer layer comprise a coating on one or both sides. In some embodiments, at least the first inner polymer layer comprises a coating on one side. In some embodiments, at least the first inner polymer layer comprises a coating on both sides. In some embodiments, at least the first outer polymer layer comprises a coating on one side. In some embodiments, at least the first outer polymer layer comprises a coating on both sides. In some embodiments, at least the second outer polymer layer comprises a coating on one side. In some embodiments, at least the second outer polymer layer comprises a coating on both sides. In some embodiments, the coating is selected from the group consisting of a shellac-based coating, a cellulose-based coating (such as a nitrocellulose coating), a plasma-deposited siloxane-based coating, or mixtures thereof.

In some embodiments, the biodegradable sheet as disclosed herein is used to prepare a biodegradable package, such as a bag or pouch, for example for containing therein an ingestible substance such as a food, drink or medicine, which may be a solid, semi-solid or liquid substance. For example, in some embodiments, the biodegradable package is prepared by heat sealing of two or more parts of the same sheet or two or more separate sheets. In some such embodiments, the layer referred to herein as a first outer layer serves as a contact layer, having direct contact with the contents of the biodegradable package.

In some embodiments, the biodegradable sheet according has a degradation time in the range of 4 to 24 months. In some embodiments, the biodegradable sheet according has a shelf life of up to 12 months or up to 18 months.

Many modifications and variations are possible in light of the above teachings. It is, therefore, to be understood that within the scope of the appended claims, the invention can be practiced otherwise than as specifically described.

The specific embodiments listed below exemplify aspects of the teachings herein and are not to be construed as limiting.

Throughout this application, various publications, including United States Patents, are referenced by author and year and patents by number. The disclosures of these publications and patents and patent applications in their entireties are hereby incorporated by reference into this application in order to more fully describe the state of the art to which this invention pertains.

Citation of any document herein is not intended as an admission that such document is pertinent prior art, or considered material to the patentability of any claim of the present disclosure. Any statement as to content or a date of any document is based on the information available to applicant at the time of filing and does not constitute an admission as to the correctness of such a statement.

### EXAMPLES

In the experimental section below, all percentages are weight percentages.

Materials and Methods

All the embodiments of polymer sheets according to the teachings herein were made using commercially-available raw materials and devices, using one or more standard methods including: polymer resin drying, resin mixing, cast film extrusion, cast film co-extrusion, blown film extrusion and coextrusion and adhesive lamination.

Materials

The following polymer resins and raw materials were acquired from commercial sources:
PCL poly(epsilon-caprolactone)
PLA poly(lactic acid)
PBS poly(butylene succinate)
PBSA poly(butylene succinate adip ate)
PBAT poly(butylene adipate terphtalate)

Resin Drying

Before use, resins were dried overnight in an air flow Shini SCD-160U-120H desiccant dryer heated to 50° C.

Resin Mixtures

As seen from Tables 1 and 2, some embodiments of the polymer sheets according to the teachings herein included layers comprising a polymer mixture. Such layers were made by extrusion/coextrusion of a polymer mixture resin.

To make the required polymer mixture resins, the appropriate amounts of the dried constituent resins were dry-blended, introduced into the feed of a twin screw compounder and then melt extruded to form a polymer mixture resin. During melt extrusion in the compounder, the temperature zone settings were 170-175-180-185-190° C. die at 190° C., a screw speed of 350 rpm and pressure 15-25 bar.

The compounded polymer resin was ground into 1-5 mm diameter pellets using strand pelletizer.

Cast Film Coextrusion of Sheets

Some embodiments of sheets according to the teachings herein were made by coextrusion of three layers to make a desired sheet by multilayer cast film co extrusion.

Some embodiments of sheets according to the teachings herein were made by lamination of single and multilayer cast film extruded films

Films and sheets were made using a cast film coextruder Dr. Collin (Collin Lab and Pilot Solutions) using standard settings, typically the mixture was feed into the extruder with the temperature zone settings 170-180-200° C.; Adaptor at 200° C.; feedblock at 200° C.; Die at 200° C. The screw speed was set to provide an extruded layer having the desired thickness in the usual way. For multilayer films, a die having three ports, each fed by a dedicated extruder was used.

### Example 1

### Effect of PBSA Content on Dart Drop Impact

Biodegradable sheets comprising PBSA and PLA, at varying concentrations, as shown in Table 1, were prepared by cast film extrusion.

TABLE 1

| PBSA (%) | 0 | 25 | 50 | 60 | 75 | 80 | 85 | 90 | 95 | 100 |
|---|---|---|---|---|---|---|---|---|---|---|
| PLA (%) | 100 | 75 | 50 | 40 | 30 | 20 | 15 | 10 | 5 | 0 |

Dart drop impact was measured for each film, using the Free-Falling Dart Method ASTM D1709.

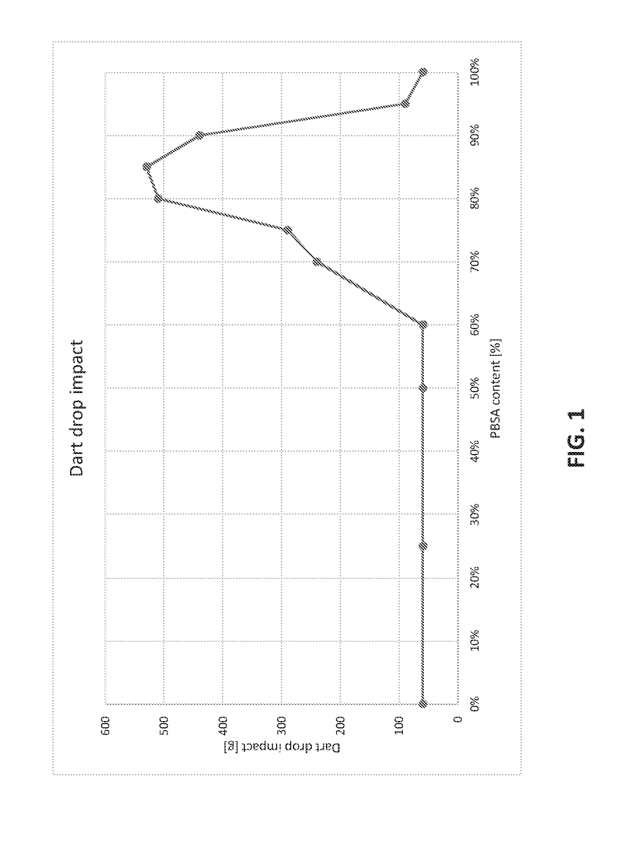

Results are presented in FIG. 1, in which the x axis shows the percentage of PBSA in each film and the y axis shows dart drop impact in grams

As shown in FIG. 1, biodegradable films comprising from about 70 to about 90% PBSA and from about 10% to about 30% PLA showed high values of dart drop impact, with highest value for 85% PBSA and 15% PLA.

### Example 2

### Specific Embodiments of Sheets According to the Teachings Disclosed Herein

Exemplary sheets 1-10, representing specific embodiments according to the teachings disclosed herein were prepared, according to Table 2, in which T refers to the layer thickness in micrometers (μm).

TABLE 2

| # | First outer layer | T | First inner layer | T | Second outer layer | T |
|---|---|---|---|---|---|---|
| 1 | PBSA | 4 | PBSA(85%):PLA(15%) | 15 | PBSA | 4 |
| 2 | PBSA | 4 | PBSA(85%):PLA(15%) | 15 | PBS | 4 |
| 3 | PLA (60%):PCL(40%) | 20 | PBSA(85%):PLA(15%) | 15 | PBSA | 4 |
| 4 | PLA (54%):PCL(36%):PBS(10%) | 20 | PBSA(85%):PLA(15%) | 15 | PBS | 4 |
| 5 | PLA (60%):PCL(40%) | 20 | PBSA(85%):PLA(15%) | 15 | PBS | 4 |
| 6 | PLA (54%):PCL(36%):PBS(10%) | 20 | PBSA(85%):PLA(15%) | 15 | PBSA | 4 |
| 7 | PBSA | 4 | PBSA(75%):PLA(25%) | 15 | PBSA | 4 |
| 8 | PBSA | 4 | PBSA(75%):PLA(25%) | 15 | PBS | 4 |
| 9 | PBSA(75%):PLA(25%) | 15 | PBAT | 15 | PBSA | 4 |
| 10 | PBSA(85%):PLA(15%) | 15 | PLA (60%):PCL(40%) | 20 | PBSA | 4 |

The sheets were prepared as follows:

Sheet #1 made by cast film coextrusion of
4 μm PBSA (extruder I),
15 μm 85% PBSA: 15% PLA (extruder II),
4 μm PBSA (extruder III),

Sheet #2 made by cast film coextrusion of
4 μm PBSA (extruder I),
15 μm 85% PBSA: 15% PLA (extruder II),
4 μm PBS (extruder III),

Sheet #3 made by cast film coextrusion of
20 μm 60% PLA: 40% PCL (extruder I),
15 μm 85% PBSA: 15% PLA (extruder II),
4 μm PBSA (extruder III),

Sheet #4 made by cast film coextrusion of
20 μm 54% PLA: 36% PCL:10% PBS (extruder I),
15 μm 85% PBSA: 15% PLA (extruder II),
4 μm PBS (extruder III),

Sheet #5 made by cast film coextrusion of
20 μm 60% PLA: 40% PCL (extruder I),
15 μm 85% PBSA: 15% PLA (extruder II),
4 μm PBS (extruder III),

Sheet #6 made by cast film coextrusion of
20 μm 54% PLA: 36% PCL: 10% PBS (extruder I),
15 μm 85% PBSA: 15% PLA (extruder II),
4 μm PBSA (extruder III),

Sheet #7 made by cast film coextrusion of
4 μm PBSA (extruder I),
15 μm75% PBSA: 25% PLA (extruder II),
4 μm PBSA (extruder III),

Sheet #8 made by cast film coextrusion of
4 μm PBSA (extruder I),
15 μm75% PBSA: 25% PLA (extruder II),
4 μm PBS (extruder III),

Sheet #9 made by cast film coextrusion of
15 μm75% PBSA: 75% PLA (extruder I),
15 μm PBAT (extruder II),
4 μm PBSA (extruder III),

Sheet #10 made by cast film coextrusion of
15 μm 85% PBSA: 15% PLA (extruder I),
20 μm 60% PLA: 40% PCL (extruder II),
4 μm PBSA (extruder III),

### Example 3

### Physical Properties of Specific Embodiments of Sheets According to the Teachings Disclosed Herein

Exemplary sheets 11-18, representing specific embodiments according to the teachings disclosed herein were prepared, according to Table 3, in which T refers to the layer thickness in micrometers (μm).

TABLE 3

| # | First outer layer | T | First inner layer | T | Second outer layer | T |
|---|---|---|---|---|---|---|
| 11 | PBSA | 4 | PBSA(85%):PLA(15%) | 32 | PBSA | 4 |
| 12 | PBS | 6 | PBSA(85%):PLA(15%) | 31 | PBSA | 3 |
| 13 | PBSA | 10 | PBSA(85%):PLA(15%) | 30 | PBS | 10 |
| 14 | PBSA(85%):PLA(15%) | 16 | PBSA(85%):PLA(15%) | 17 | PBSA(85%):PLA(15%) | 16 |
| 15 | PBSA(85%):PLA(15%) | 6 | PBAT | 31 | PBSA | 3 |
| 16 | PBSA(85%):PLA(15%) | 20 | PBAT (90%):PLA(10%) | 40 | PBSA | 20 |
| 17 | PBSA(85%):PLA(15%) | 10 | PBAT | 15 | PBSA | 5 |
| 18 | PBSA(85%):PLA(15%) | 8 | PBAT | 17 | PBSA | 5 |

The sheets were prepared as follows:

Sheet #11 made by cast film coextrusion of
4 μm PBSA (extruder I),
32 μm 85% PBSA: 15% PLA (extruder II),
4 μm PBSA (extruder III),

Sheet #12 made by cast film co extrusion of
6 μm PBS (extruder I),
31 μm 85% PBSA: 15% PLA (extruder II),
3 μm PBSA (extruder III),

Sheet #13 made by cast film coextrusion of
10 μm PBSA (extruder I),
30 μm 85% PBSA: 15% PLA (extruder II),
10 μm PBS (extruder III),

Sheet #14 made by cast film coextrusion of
16 μm 85% PBSA: 15% PLA (extruder I),
17 μm 85% PBSA: 15% PLA (extruder II),
16 ∞m 85% PBSA: 15% PLA (extruder III),

Sheet #15 made by cast film coextrusion of
6 μm 85% PBSA: 15% PLA (extruder I),
31 μm PBAT (extruder II),
3 μm PBSA (extruder III),

Sheet #16 made by cast film coextrusion of
20 μm 85% PBSA: 15% PLA (extruder I),
40 μm 90% PBAT: 10% PLA (extruder II),
20 μm PBSA (extruder III),

Sheet #17 made by cast film coextrusion of
10 μm 85% PBSA: 15% PLA (extruder I),
15 μm PBAT (extruder II),
5 μm PBSA (extruder III),

Sheet #18 made by cast film coextrusion of
8 μm 85% PBSA: 15% PLA (extruder I),
17 μm PBAT (extruder II),
5 μm PBSA (extruder III),

The mechanical properties of the films were tested [ASTM D882; machine direction (MD) and trans-machine direction (TD)] and impact, which was measured using the ASTM D1709 Standard Test Method for Impact Resistance of Plastic Film by the Free-Falling Dart.

Results are presented in Tables 4.

TABLE 4

| | | Young's | Young's | Stress at | Stress at | | |
|---|---|---|---|---|---|---|---|
| | Dart drop | Modulus | Modulus | Break -MD | Break - TD | % Strain at | % Strain at |
| Sheet # | (g) | MD-(MPa) | TD-(MPa) | (MPa) | (MPa) | Break - MD | Break - TD |
| 11 | 353 | 544 | 375 | 28 | 17 | 248 | 359 |
| 12 | 377 | 511 | 431 | 29 | 14 | 227 | 5 |
| 13 | 498 | 472 | 365 | 19 | 19 | 110 | 256 |
| 14 | 251 | 560 | 414 | 14 | 13 | 13 | 6 |
| 15 | 1220 | 90 | 102 | 24 | 14 | 354 | 538 |
| 16 | 1330 | 405 | 198 | 25 | 18 | 512 | 566 |
| 17 | 206 | 198 | 170 | 22 | 15 | 211 | 531 |
| 18 | 188 | 131 | 160 | 27 | 9 | 195 | 218 |

As seen in Table 4, multilayer sheets comprising 70-90% (w/w) PBSA: 5-30% (w/w) PLA as an inner layer (sheets #11-14) showed excellent mechanical properties in terms of impact resistance, flexibility and physical strength, as measured by the dart drop test, Young's modulus and stress and strain at break, respectively.

As further seen in Table 4, multilayer sheets comprising 70-90% (w/w) PBSA: 5-30% (w/w) PLA as an outer layer, in combination with an inner layer comprising PBAT (either alone or in combination with PLA) (sheets #15-18), similarly showed excellent mechanical properties in terms of impact resistance, flexibility and physical strength.

For comparative purposes, sheets #19-22, which comprise neither an inner layer comprising 70-90% (w/w) PBSA: 5-30% (w/w) PLA nor an outer layer comprising 70-90% (w/w) PBSA: 5-30% (w/w) PLA in combination with an inner layer comprising PBAT were prepared according to Table 5, and the mechanical properties tested. Results are presented in Table 6.

TABLE 5

| # | First outer layer | T | First inner layer | T | Second outer layer | T |
|---|---|---|---|---|---|---|
| 19 | PBSA | 10 | PBAT | 30 | PBS | 10 |
| 20 | PLA | 10 | PBAT | 20 | PLA | 10 |
| 21 | PBSA(75%):PLA(25%) | 20 | PBSA | 20 | PBSA(75%):PLA(25%) | 20 |
| 22 | PBSA(75%):PLA(25%) | 8 | PBS | 8 | PBSA | 8 |

TABLE 6

| | | Young's | Young's | Stress at | Stress at | | |
|---|---|---|---|---|---|---|---|
| | Dart drop | Modulus | Modulus | Break -MD | Break - TD | % Strain at | % Strain at |
| Sheet # | (g) | MD-(MPa) | TD-(MPa) | (MPa) | (MPa) | Break - MD | Break - TD |
| 19 | 482 | 129 | 145 | 20 | 19 | 393 | 550 |
| 20 | <59 | 1,194 | 1,279 | 22 | 25 | 37 | 3 |
| 21 | <59 | 942 | 709 | 20 | 19 | 15 | 5 |
| 22 | <59 | 2432 | N/A | 63.7 | N/A | 89 | N/A |

N/A denotes for not available

As shown in Table 6, sheets #19-22 demonstrated low impact resistance as measured by the dart drop test, and/or poor results in terms of flexibility and/or physical strength as measured by Young's modulus and stress and strain at break.

The inventions illustratively described herein may suitably be practiced in the absence of any element or elements, limitation or limitations, not specifically disclosed herein. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise indicated.

Although the above examples have illustrated particular ways of carrying out embodiments of the invention, in practice persons skilled in the art will appreciate alternative ways of carrying out embodiments of the invention, which are not shown explicitly herein. It should be understood that the present disclosure is to be considered as an exemplification of the principles of this invention and is not intended to limit the invention to the embodiments illustrated. Those skilled in the art will recognize, or be able to ascertain using no more than routine experimentation, equivalents of the specific embodiments of the invention described herein. Such equivalents are intended to be encompassed by the following claims.

1. A biodegradable sheet comprising a first outer polymer layer, a second outer polymer layer and at least a first inner polymer layer between said first and said second outer polymer layers, wherein said first inner polymer layer comprises about 85% (w/w) PBSA and about 15% (w/w) PLA.

2-4. (canceled)

5. The biodegradable sheet according to claim 1, wherein said first outer polymer layer comprises PBSA.

6. The biodegradable sheet according to claim 1, wherein said second outer polymer layer comprises PBSA.

7. The biodegradable sheet according to claim 5, wherein said second outer polymer layer comprises PBS.

8. The biodegradable sheet according to claim 6, wherein said first outer polymer layer comprises PBS.

9. The biodegradable sheet according to claim 1, wherein at least one of said first outer layer and said second outer layer comprises from about 70 to about 90% (w/w) PBSA and from about 5 to about 35% (w/w) PLA.

10. The biodegradable sheet according to claim 9, wherein at least one of said first outer layer and said second outer layer comprises from about 75 to about 85% (w/w) PBSA and from about 15 to about 25% (w/w) PLA.

11. The biodegradable sheet according to claim 10, wherein at least one of said first outer layer and said second outer layer comprises about 85% (w/w) PBSA and about 15% (w/w) PLA.

12. The biodegradable sheet according to claim 10, wherein said first inner polymer layer comprises about 75% (w/w) PBSA and about 25% (w/w) PLA.

13. A biodegradable sheet, comprising a first outer polymer layer, a second outer polymer layer and at least a first inner polymer layer between said first and said second outer polymer layers, wherein said first outer polymer layer comprises about 85% (w/w) PBSA and 15% (w/w) PLA.

14-16. (canceled)

17. The biodegradable sheet according to claim 13, wherein said first inner polymer layer comprises PBAT.

18. The biodegradable sheet according to claim 13, wherein said first inner polymer layer comprises from about 85% to about 95% (w/w) PBAT and from about 5% to about 15% (w/w) PLA.

19. The biodegradable sheet according to claim 18, wherein said first inner polymer layer comprises about 90% (w/w) PBAT and about 10% (w/w) PLA.

20. The biodegradable sheet according to claim 13, wherein said second outer polymer layer comprises PBSA.

21. The biodegradable sheet according to claim 1, wherein said first inner polymer layer, said first outer polymer layer and said second outer polymer layer are prepared by cast sheet extrusion.

22. The biodegradable sheet according to claim 1, wherein said first inner polymer layer, said first outer polymer layer and said second outer polymer layer are prepared by blown sheet extrusion.

23. The biodegradable sheet according to claim 1, wherein at least two of said first inner polymer layer, said first outer polymer layer and said second outer polymer layer are co-extruded.

24. A biodegradable sheet comprising a first outer polymer layer, a second outer polymer layer and at least a first inner polymer layer between said first and said second outer polymer layers, wherein said first inner polymer layer comprises from about 70 to about 90% (w/w) PBSA and from about 5 to about 35% (w/w) PLA, and wherein at least one of said outer layer and said second outer layer comprises about 85% (w/w) PBSA and 15% (w/w) PLA.

25. A biodegradable sheet, comprising a first outer polymer layer, a second outer polymer layer and at least a first inner polymer layer between said first and said second outer polymer layers, wherein said first outer polymer layer comprises from about 70 to about 90% (w/w) PBSA and from about 10 to about 30% (w/w) PLA, and wherein said first inner polymer layer comprises from about 85% to about 95% (w/w) PBAT and from about 5% to about 15% (w/w) PLA.
